(19) United States
(12) Patent Application Publication
(10) Pub. No.: US 2006/0209047 A1
(43) Pub. Date: Sep. 21, 2006

(54) Touch screen plasma display

(76) Inventor: Kwang-Jin Jeong, Suwon-si (KR)

Correspondence Address: Robert E. Bushnell, Suite 300, 1522 K Street, N.W., Washington, DC, 20005, US

(21) Appl. No.: 11/350,803

(22) Filed: Feb. 10, 2006

(30) Foreign Application Priority Data
Mar. 18, 2005 (KR) 10-2005-0022553

(51) Int. Cl. G09G 5/00

(52) U.S. Cl. 345/173

(57) ABSTRACT

A touch screen plasma display includes: a Plasma Display Panel (PDP) adapted to display images by a gas discharge, and including a front substrate, front electrodes extending in a predetermined direction on a rear portion of the front substrate, a rear substrate facing the front substrate, rear electrodes extending in a direction crossing the front electrodes on a front portion of the rear substrate, barrier ribs arranged between the front substrate and the rear substrate to define discharge spaces where the front and rear electrodes are commonly disposed, phosphor layers arranged in the discharge spaces, and a discharge gas contained within the discharge spaces; an image displaying circuit unit adapted to supply driving control signals to the front electrodes and the rear electrodes to cause the PDP to display the images; and a position detecting circuit unit adapted to communicate with the image displaying circuit unit, to detect position information signals from the front and rear electrodes generating induced currents by an electronic pen that changes a magnetic flux, to process the signals into a position coordinate signal of the electronic pen, and to transmit the position coordinate signal to the image displaying circuit unit.

### CLAIM OF PRIORITY

This application makes reference to, incorporates the same herein, and claims all benefits accruing under 35 U.S.C. §119 from an application for PLASMA DISPLAY APPARATUS OF TOUCH SCREEN TYPE earlier filed in the Korean Intellectual Property Office on Mar. 18, 2005 and there duly assigned Serial No. 10-2005-0022553.

### BACKGROUND OF THE INVENTION

1. Field of the Invention

The present invention relates to a touch screen plasma display.

2. Description of the Related Art

Plasma displays are flat panel displays which display images using a gas discharge, and are considered to be the next generation of flat panel displays that can replace cathode ray tubes due to excellent display properties such as display capacity, brightness, contrast, residual image, and viewing angle.

The plasma display can be realized as a touch screen display by installing a device such as a touch panel onto a surface displaying images. The touch screen is a direct input device that works by simply touching a screen. That is, when a user touches characters or pictures displayed on the screen by a finger or an object, the user's selection is recognized according to the touching position and a certain operation is processed using stored software. The touch panel can be a resistive touch panel, a capacitive touch panel, an optical touch panel, a microwave touch panel, or pressure touch panel.

A conventional resistive touch panel includes a transparent upper substrate and a lower substrate parallel to the upper substrate, and transparent conductive layers, such as Indium Tin Oxide (ITO), formed on a lower surface of the upper substrate and on an upper surface of the lower substrate. In addition, two upper electrodes parallel to each other are formed on a lower surface of the transparent conductive layer formed on the upper substrate, and two lower electrodes are formed on an upper surface of the transparent conductive layer formed on the lower substrate to cross the upper electrodes. When the user pushes the touch panel in a predetermined position on the upper substrate using a pressing unit such as a finger, the transparent conductive layers of the upper and lower substrates contact each other in that area, and accordingly, an electric signal is changed. The changed electric signal is input into an external circuit and processed, and thus, the coordinates of the point of contact where the pressure is applied can be found.

The touch panel is separately formed and attached onto the surface of the plasma display which displays the images, and thus, the manufacturing costs are high. In addition, when the touch panel cannot be tightly adhered to the surface of the plasma display, an air layer can occur between the touch panel and the plasma display, thus degrading the visibility of the screen.

### SUMMARY OF THE INVENTION

The present invention provides a touch screen plasma display which displays images by recognizing a position coordinate of an electronic pen through an electromagnetic induction between electrodes formed on a Plasma Display Panel (PDP) and the electronic pen.

According to one aspect of the present invention, a touch screen plasma display is provided including: a Plasma Display Panel (PDP) adapted to display images by a gas discharge, and including a front substrate, front electrodes extending in a predetermined direction on a rear portion of the front substrate, a rear substrate facing the front substrate, rear electrodes extending in a direction of crossing the front electrodes on a front portion of the rear substrate, barrier ribs arranged between the front substrate and the rear substrate to define discharge spaces where the front and rear electrodes can be commonly disposed, phosphor layers arranged in the discharge spaces, and a discharge gas contained within the discharge spaces; an image displaying circuit unit adapted to supply driving control signals to the front electrodes and the rear electrodes to cause the PDP to display the images; and a position detecting circuit unit communicating with the image displaying circuit unit, and adapted to detect position information signals from the front and rear electrodes to generate induced currents by an electronic pen that changes a magnetic flux, to process the signals into a position coordinate signal of the electronic pen, and to transmit the position coordinate signal to the image displaying circuit unit.

The electronic pen preferably includes a coil, and wherein an Alternating Current (AC) is supplied to the coil to change the magnetic flux.

The front electrodes are preferably adapted to perform as sustain electrode pairs including common electrodes and scan electrodes to generate a sustain discharge, and the rear electrodes are preferably adapted to perform as address electrodes to generate an address discharge with the scan electrodes.

The position detecting circuit unit is preferably adapted to communicate with the scan electrodes and the address electrodes.

The front electrode preferably includes a transparent electrode of a transparent conductive material, and a bus electrode connected to the transparent electrode and adapted to supply driving control signals to the transparent electrode.

The touch screen plasma display further includes a dielectric layer adapted to cover at least one of the front electrodes and the rear electrodes.

The touch screen plasma display preferably further includes at least a chassis base arranged between the PDP and the image displaying circuit unit and adapted to support the PDP and the image displaying circuit unit.

According to another aspect of the present invention, a touch screen plasma display is provided including: a Plasma Display Panel (PDP) adapted to display images by a gas discharge, and including a front substrate, sustain electrode pairs extending in a predetermined direction on a rear portion of the front substrate and including pairs of common electrodes and scan electrodes, a front dielectric layer adapted to cover the sustain electrode pairs, a rear substrate facing the front substrate, address electrodes extending in a direction crossing the sustain electrode pairs on a front portion of the rear substrate, a rear dielectric layer adapted to cover the address electrodes, barrier ribs arranged between the front substrate and the rear substrate to define discharge spaces where the sustain electrode pairs and the address electrodes are commonly disposed, phosphor layers arranged in the discharge spaces, and a discharge gas contained within the discharge spaces; an image displaying circuit unit adapted to supply driving control signals to the sustain electrode pairs and the address electrodes to cause the PDP to display the images; and a position detecting circuit unit adapted to communicate with the image displaying circuit unit, to detect position information signals from the address electrode and the scan electrode generating induced currents by an electronic pen that changes magnetic flux, to process the signals into position coordinate signal of the electronic pen, and to transmit the position coordinate signal to the image displaying circuit unit.

The electronic pen preferably includes a coil, and wherein an Alternating Current (AC) voltage is supplied across both ends of the coil to change the magnetic flux.

The barrier ribs preferably include one of a matrix or stripes.

The touch screen plasma display preferably further includes a protective layer adapted to cover a rear surface of the front dielectric layer.

The touch screen plasma display preferably further includes at least a chassis base arranged between the PDP and the image displaying circuit unit and adapted to support the PDP and the image displaying circuit unit.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a touch screen plasma display according to an embodiment of the present invention;

FIG. 2 is an exploded perspective view of a part of a Plasma Display Panel (PDP) of FIG. 1;

FIG. 3 is a block diagram of the touch screen plasma display of FIG. 1; and

FIG. 4 is a schematic diagram of an example of arranging electrodes and circuit units in the touch screen plasma display of FIG. 1.

### DETAILED DESCRIPTION OF THE INVENTION

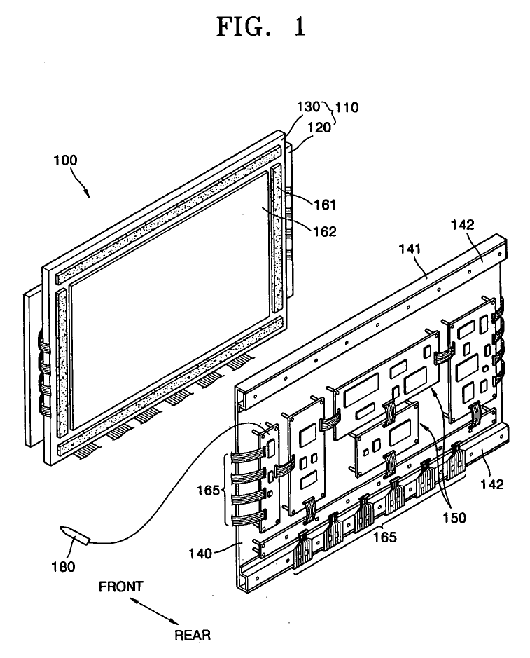

FIG. 1 is an exploded perspective view of a touch screen plasma display 100 according to an embodiment of the present invention.

Referring to FIG. 1, the touch screen plasma display 100 includes a Plasma Display Panel (PDP) 110 which displays images by a gas discharge.

A chassis base 140 is disposed on a rear portion of the PDP 110. The chassis base 140 is formed of aluminum, and is disposed parallel to the PDP 110 to support the PDP 110 and to dissipate heat generated by the PDP 110 to the outside. The chassis base 140 can include a bending portion 141 formed by bending an edge of the chassis base 140 backward in order to prevent bending or curving transformation. In addition, reinforcing members 142 can be installed on a rear portion of the chassis base 140. The reinforcing members 142 are formed of metal and attached to the rear surface of the chassis base to prevent the chassis base 140 from bending or curving. In addition, the reinforcing members 142 increase the heat dissipation area of the chassis base 140, thereby increasing the heat dissipation efficiency.

The chassis base 140 is attached to the PDP 110 by an adhesive member 161, such as double-sided adhesive tape, and a thermal conductive member 162 is disposed between the chassis base 140 and the PDP 110 to transmit the heat generated by the PDP 110 to the chassis base 140, and thus, dissipate the heat.

A circuit unit 150, on which various electronic elements are mounted, is installed on a rear portion of the chassis base 140. The circuit unit 150 is electrically connected to the PDP 110 through a connection member 165 to transmit various signals. The connection member 165 can be a Flexible Printed Cable (FPC) or a Tape Carrier Package (TCP) formed by mounting at least a device on the FPC. In addition, an electronic pen 180 for touching the screen is electrically connected to the circuit unit 150. The circuit unit 150 is accommodated in a case (not shown) with the PDP 110 and the chassis base 140, and thus, the touch screen plasma display 100 is finalized.

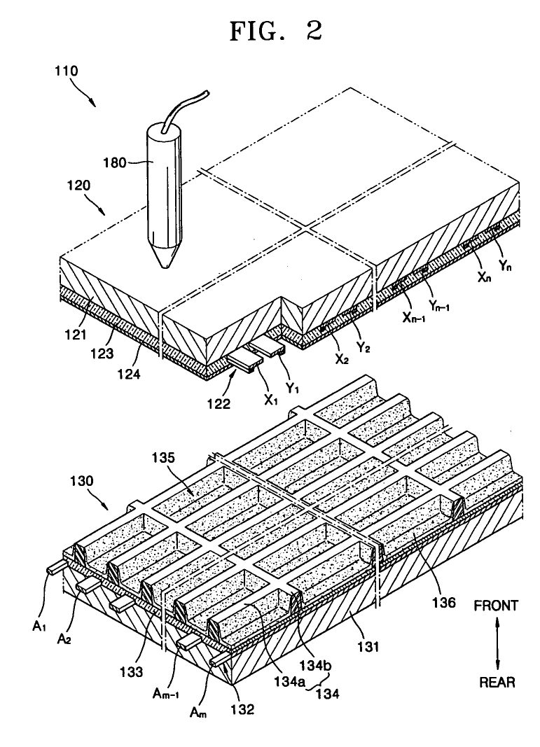

Various kinds of PDPs can be used as the PDP 110, for example, an Alternating Current (AC) PDP having a surface-discharge three-electrode structure as shown in FIG. 2.

The PDP 110 includes a front panel 120, and a rear panel 130 coupled to the front panel 120.

The front panel 120 includes a front substrate 121, and the front substrate 121 can be formed of a transparent glass having a high light transmittance so that the image can be transmitted through the substrate 121. Front electrodes 122 are separately arranged on a rear portion of the front substrate 121.

The front electrodes 122 can be formed as sustain electrode pairs, each of which includes a common electrode X1, X2, . . . , Xn−1, or Xn and a scan electrode Y1, Y2, . . . , Yn−1, or Yn forming a discharge gap therebetween, to cause a sustain discharge. In addition, the common electrode X1, X2, . . . , Xn−1, or Xn includes a common transparent electrode formed on a rear surface of the front substrate 121 and a common bus electrode connected to the rear surface of the common transparent electrode, and the scan electrode Y1, Y2, . . . , Yn−1, or Yn includes a scan transparent electrode formed on the rear surface of the front substrate 121 and a scan bus electrode connected to the rear surface of the scan transparent electrode. The common and scan transparent electrodes are formed of a transparent material, for example, Indium Tin Oxide (ITO), so that visible light can be transmitted therethrough. In addition, the common and scan transparent electrodes are formed to have smaller widths than those of the common and scan transparent electrodes and are connected to the common and scan transparent electrodes to supply driving control signals. The common and scan bus electrodes can be formed of highly conductive metal in order to lower the electric resistances of the common and scan transparent electrodes formed of ITO having a poorer electrical conductivity.

The front electrodes 122 can be covered by a front dielectric layer 123 formed of a dielectric material on the rear surface of the front substrate 121, and a rear surface of the front dielectric layer 123 can be covered by a protected layer 124. The protective layer 124 can be formed of an MgO layer for preventing the front dielectric layer 123 from being damaged by ions generated during the discharge and for improving the light emission efficiency by discharging secondary electrodes.

The rear panel 130 facing the front panel 120 includes a rear substrate 131. Rear electrodes 132 are separately arranged on a front surface of the rear substrate 131 in a direction of crossing the front electrodes 122. The rear electrodes 132 perform as address electrodes A1, A2, . . . , Am−1, Am generating address discharge with the scan electrodes Y1, Y2, . . . , Yn−1, and Yn when the front electrodes 122 perform as sustain electrode pairs. The address electrodes A1, A2, . . . , Am−1, and Am are formed as strips on the front surface of the rear substrate 131, and can be covered by a rear dielectric layer 133 formed of a dielectric material on the rear substrate 131.

Barrier ribs 134 formed as a matrix are formed on the front surface of the rear dielectric layer 133 so as to define discharge spaces of predetermined patterns, for example, discharge cells 135 with four closed sides as shown in FIG. 2. The barrier ribs 134 prevent cross talk from being generated between neighboring discharge cells 135. In more detail, the barrier ribs can include first barrier ribs 134a extending in a predetermined direction and separately formed with each other, and second barrier ribs 134b extending in a direction of crossing the first barrier ribs 134 from side surfaces of the first barrier ribs 134a and separated from each other. The first barrier ribs 134a interpose at least an address electrode A1, A2, . . . , Am−1, or Am and are disposed parallel to the address electrode. In addition, the barrier ribs can be formed in any other structure that defines discharge cells as the arrangement pattern of the pixels.

Phosphor layers 136 that are excited by ultraviolet rays generated during the discharge to emit visible light are disposed in the discharge cells 135. The phosphor layers 136 are formed on the side surfaces of the barrier ribs 134 and on the front surface of the rear dielectric layer 133 surrounded by the barrier ribs 134. Each of the phosphor layers 136 is formed of one material selected from among red, green, and blue phosphor materials that respectively emit red, green, and blue visible light, and thus, the phosphor layers 136 include red, green, and blue phosphor layers. In addition, the discharge cells 135 can form red, green, and blue sub-pixels according to the phosphor layers disposed thereon. The red, green, and blue sub-pixels form a unit pixel, and thus various colors can be displayed by combining the three primary colors. A discharge gas is contained within the discharge cells 135, and the front panel 120 and the rear panel 130 are sealed together by a sealing member (not shown) formed on the edges of the front and rear panels 120 and 130.

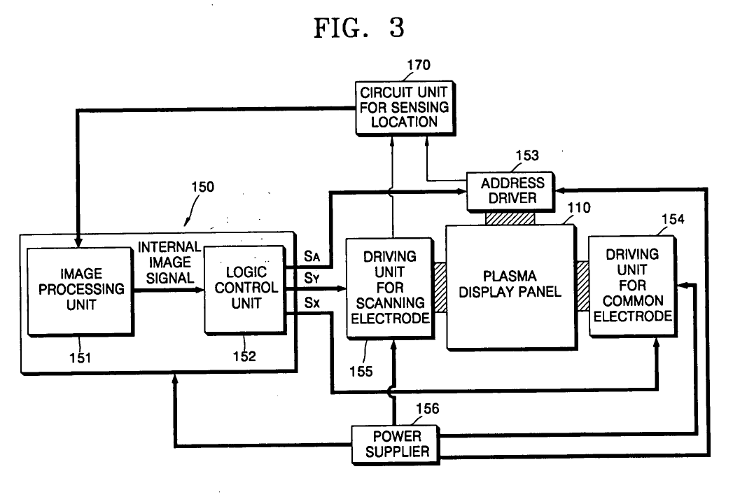

The PDP 110 having the above structure can be driven by the circuit unit 150 of FIG. 3.

Referring to FIG. 3, the circuit unit 150 includes an image displaying circuit unit for displaying images of the PDP 110. The image displaying circuit unit includes an image processor 151, a logic controller 152, an address driver 153, a common driver 154, a scan driver 155, and a power supplier 156.

The image processor 151 generates internal image signals, for example, red, green, and blue image data signals of 8 bits, a clock signal, and a horizontal and vertical synchronization signals, using stored software. The logic controller 152 generates driving control signals SA, SY, and SX according to the internal image signals of the image processor 151. The address driver 153 processes the address signal SA among the driving control signals SA, SY, and SX of the logic controller 152 to generate a display data signal, and supplies the generated display data signal to the address electrodes A1, A2, . . . , Am−1, and Am. The common driver 154 processes the common driving control signal SX among the driving control signals SA, SY, and SX of the logic controller 152, and supplies the signal SX to the common electrodes X1, X2, . . . , Xn−1, and Xn. The scan driver 155 processes the scan driving control signal SY among the driving control signals SA, SY, and SX of the logic controller 152 and supplies the signal SY to the scan electrodes Y1, Y2, . . . , Yn−1, and Yn. In addition, the power supplier 156 supplies operational voltages required by the image processor 151 and the logic controller 152, and operational voltage required by the address driver 153, the common driver 154, and the scan driver 155.

The image displaying circuit unit can be driven by an Address-Display Separation (ADS) method wherein one image frame is time-divided into 8 sub-fields and address discharge and sustain discharge are timely separated to display 256 gradation levels for displaying the images from the PDP 110.

According to the present invention, the circuit unit 150 can include a position detecting circuit unit 170. The position detecting circuit unit 170 receives a signal including position information of the electronic pen 170 from the address driver 153 and the scan driver 155, and processes the position coordinate signal of the electronic pen 180 based on the signal. In addition, the circuit unit 150 is connected to the image displaying circuit unit so as to transmit the position coordinate signal to the image processor 151.

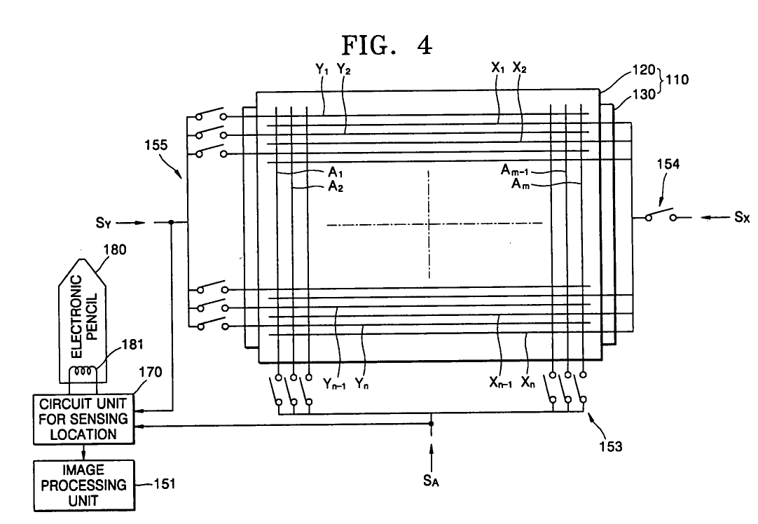

Referring to FIG. 4, the common electrodes X1, X2, . . . , Xn−1, and Xn and the scan electrodes Y1, Y2, . . . , Yn−1, Yn formed on the PDP 110 extend parallel to each other in a predetermined direction, and the address electrodes A1, A2, . . . ,Am−1, and Am extend in a direction crossing the common electrodes X1, X2, . . . , Xn−1, and Xn and the scan electrodes Y1, Y2, . . . , Yn−1, Yn, and thus, the electrodes form matrix. The ends of the common electrodes X1, X2, . . . , Xn−1, and Xn at one side of the plasma display 100 are commonly connected and form a circuit turned on/off by the signal transmitted to the common driver 154, and the ends of the scan electrodes Y1, Y2, . . . , Yn−1, Yn at other side of the plasma display 100 are separated from each other and form circuits turned on/off by the signal transmitted to the scan driver 155. In addition, the ends of the address electrodes A1, A2, . . . , Am−1, and Am at a lower side of the plasma display 100 are separated from each other, and form circuits turned on/off by the signal transmitted to the address driver 153. Among the common electrodes, the scan electrodes, and the address electrodes, the scan electrodes Y1, Y2, . . . , Yn−1, Yn and the address electrodes A1, A2, . . . , Am−1, Am addressing the discharge cells 135 communicate with the position detecting circuit unit 170, and thus, the position information of the electronic pen 180 can be detected by electromagnetic induction.

That is, the scan electrodes Y1, Y2, . . . , Yn−1, Yn and the address electrodes A1, A2, . . . , Am−1, and Am formed on the PDP 110 perform as antennas detecting the position of the electronic pen 180, and the electronic pen 180 changes a magnetic flux so that an induced current can be generated on the scan electrodes Y1, Y2, . . . , Yn−1, and Yn and the address electrodes A1, A2, . . . , Am−1, and Am by the electromagnetic induction. The position detecting circuit unit 170 processes the signals from the scan electrodes Y1, Y2, . . . , Yn−1, Yn and the address electrodes A1, A2, . . . , Am−1, and Am on which the induced current is generated, and thus, the position coordinate of the electronic pen 180 can be obtained. The electronic pen 180 includes a coil 181 therein for changing the magnetic flux, and an Alternating Current (AC) is supplied to the coil 181 from the position detecting circuit unit 170.

As described above, in the touch screen plasma display 100 having the above structure, when a user touches an area of the screen by the electronic pen 180, the magnetic flux in the area is changed, and an induced current is generated on the scan electrode Y1, Y2, . . . , Yn−1, or Yn and the address electrodes A1, A2, . . . , Am−1, or Am located in the area touched by the pen 180. The signals from the scan electrodes Y1, Y2, . . . , Yn−1, or Yn and the address electrodes A1, A2, . . . , Am−1, or Am, on which the induced current is generated, are transmitted to the position detecting circuit unit 170. In addition, one of the signals from the scan electrode Y1, Y2, . . . , Yn−1, or Yn and the address electrode A1, A2, . . . , Am−1, or Am includes information about the abscissa of the electronic pen 180 and the other includes information about the ordinate of the electronic pen 180, and thus, when the signals from the scan electrode Y1, Y2, . . . , Yn−1, or Yn and the address electrode A1, A2, . . . , Am−1, or Am are transmitted to the position detecting circuit unit 170 and the position detecting circuit unit 170 processes the signals, the position coordinate signal of the electronic pen 180 can be obtained. The obtained position coordinate signal of the electronic pen 180 is transmitted to the image processor 151, and the image requested by the user can be displayed through the PDP 110 using the stored software.

According to the present invention, the scan electrodes and the address electrodes included in the PDP can perform as antennas detecting the position of the electronic pen via an electromagnetic induction phenomenon. Therefore, the conventional touch panel that is separately attached to the screen of the plasma display is not required, and accordingly, additional costs for fabricating the touch panel can be reduced. Moreover, since there is no touch panel, the visibility of the screen can be sufficiently ensured.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A touch screen plasma display comprising:
a Plasma Display Panel (PDP) adapted to display images by a gas discharge, and including a front substrate, front electrodes extending in a predetermined direction on a rear portion of the front substrate, a rear substrate facing the front substrate, rear electrodes extending in a direction of crossing the front electrodes on a front portion of the rear substrate, barrier ribs arranged between the front substrate and the rear substrate to define discharge spaces where the front and rear electrodes can be commonly disposed, phosphor layers arranged in the discharge spaces, and a discharge gas contained within the discharge spaces;
an image displaying circuit unit adapted to supply driving control signals to the front electrodes and the rear electrodes to cause the PDP to display the images; and
a position detecting circuit unit communicating with the image displaying circuit unit, and adapted to detect position information signals from the front and rear electrodes to generate induced currents by an electronic pen that changes a magnetic flux, to process the signals into a position coordinate signal of the electronic pen, and to transmit the position coordinate signal to the image displaying circuit unit.

2. The touch screen plasma display of claim 1, wherein the electronic pen comprises a coil, and wherein an Alternating Current (AC) is supplied to the coil to change the magnetic flux.

3. The touch screen plasma display of claim 1, wherein the front electrodes are adapted to perform as sustain electrode pairs including common electrodes and scan electrodes to generate a sustain discharge, and wherein the rear electrodes are adapted to perform as address electrodes to generate an address discharge with the scan electrodes.

4. The touch screen plasma display of claim 3, wherein the position detecting circuit unit is adapted to communicate with the scan electrodes and the address electrodes.

5. The touch screen plasma display of claim 3, wherein the front electrode comprises a transparent electrode of a transparent conductive material, and a bus electrode connected to the transparent electrode and adapted to supply driving control signals to the transparent electrode.

6. The touch screen plasma display of claim 1, further comprising a dielectric layer adapted to cover at least one of the front electrodes and the rear electrodes.

7. The touch screen plasma display of claim 1, further comprising at least a chassis base arranged between the PDP and the image displaying circuit unit and adapted to support the PDP and the image displaying circuit unit.

8. A touch screen plasma display comprising:
a Plasma Display Panel (PDP) adapted to display images by a gas discharge, and including a front substrate, sustain electrode pairs extending in a predetermined direction on a rear portion of the front substrate and including pairs of common electrodes and scan electrodes, a front dielectric layer adapted to cover the sustain electrode pairs, a rear substrate facing the front substrate, address electrodes extending in a direction crossing the sustain electrode pairs on a front portion of the rear substrate, a rear dielectric layer adapted to cover the address electrodes, barrier ribs arranged between the front substrate and the rear substrate to define discharge spaces where the sustain electrode pairs and the address electrodes are commonly disposed, phosphor layers arranged in the discharge spaces, and a discharge gas contained within the discharge spaces;
an image displaying circuit unit adapted to supply driving control signals to the sustain electrode pairs and the address electrodes to cause the PDP to display the images; and
a position detecting circuit unit adapted to communicate with the image displaying circuit unit, to detect position information signals from the address electrode and the scan electrode generating induced currents by an electronic pen that changes magnetic flux, to process the signals into position coordinate signal of the electronic pen, and to transmit the position coordinate signal to the image displaying circuit unit.

9. The touch screen plasma display of claim 8, wherein the electronic pen comprises a coil, and wherein an Alternating Current (AC) voltage is supplied across both ends of the coil to change the magnetic flux.

10. The touch screen plasma display of claim 8, wherein the barrier ribs comprise one of a matrix or stripes.

11. The touch screen plasma display of claim 8, further comprising a protective layer adapted to cover a rear surface of the front dielectric layer.

12. The touch screen plasma display of claim 8, further comprising at least a chassis base arranged between the PDP and the image displaying circuit unit and adapted to support the PDP and the image displaying circuit unit.
